(19) United States
(12) Patent Application Publication
(10) Pub. No.: US 2025/0185113 A1
(43) Pub. Date: Jun. 5, 2025

(54) BASE STATION, TERMINAL, AND WIRELESS COMMUNICATION SYSTEM

(71) Applicant: Fujitsu Limited, Kawasaki-shi (JP)

(72) Inventors: Huiting Cheng, Yokohama (JP); Yosuke AKIMOTO, Ichihara (JP); Tsuyoshi SHIMOMURA, Yokohama (JP)

(73) Assignee: Fujitsu Limited, Kawasaki-shi (JP)

(21) Appl. No.: 19/043,627

(22) Filed: Feb. 3, 2025

Related U.S. Application Data
(63) Continuation of application No. PCT/JP2022/030326, filed on Aug. 8, 2022.

(51) Int. Cl. H04W 76/28; H04W 52/02; H04W 72/232

(52) U.S. Cl. CPC H04W 76/28; H04W 52/0235; H04W 72/232

(57) ABSTRACT

A base station includes: a control unit that determines to cause a state of a cell to transition to a second state in which transmission of a downlink signal in the cell is restricted; and a transmitter that transmits, to a terminal, a first signal that includes first information that indicates that the cell is to transition to the second state, wherein a period of the second state is equal to or greater than a multiple of a cycle of a discontinuous reception (DRX) state of the terminal.

### CROSS-REFERENCE TO RELATED APPLICATION

This application is a continuation application of International Application PCT/JP2022/030326 filed on Aug. 8, 2022 and designated the U.S., the entire contents of which are incorporated herein by reference.

### FIELD

The embodiments discussed herein are related to a base station, a terminal, and a wireless communication system.

BACKGROUND

In current networks, traffic of mobile terminals (smartphones and feature phones) occupies most of network resources. In addition, the traffic used by the mobile terminals tends to grow in the future.

Furthermore, apart from the traffic used by the mobile terminals, for example, Internet of things (IoT) services (such as monitoring systems for traffic systems, smart meters, devices, and the like) are being developed. Therefore, the networks are desired to cope with services having a variety of expected conditions. In order to cope with such a variety of services, in communication standards for the 5th generation mobile communication (5G or New Radio (NR)), besides the fundamental techniques for the 4th generation mobile communication (4G), for example, standards have been formulated assuming support of many use cases classified into Enhanced Mobile Broadband (eMBB), Massive Machine Type Communications (MTC), and Ultra-Reliable and Low-Latency Communication (URLLC).

Note that, in the 3rd Generation Partnership Project (3GPP (registered trademark)) that is an international standardization project, extended techniques of the above communication standards are continuously and still currently studied and standardized.

In addition, in the 3GPP, a technique relating to energy saving of a base station by cooperation between the base station and a terminal has been studied. Furthermore, as a technique relating to energy saving of a base station, a technique for putting a cell containing a base station into sleep (hereinafter, will be sometimes referred to as a cell sleep), and a technique for turning off some transmission units and a technique for reducing transmission power (hereinafter, a state to which the technique for turning off some transmission units and/or the technique for reducing transmission power is applied will be sometimes referred to as a power saving transmission state) have been proposed.

3GPP TS 36.133 V17.6.0, 3GPP TS 36.211 V17.2.0, 3GPP TS 36.212 V17.1.0, 3GPP TS 36.213 V17.2.0, 3GPP TS 36.214 V17.0.0, 3GPP TS 36.300 V17.1.0, 3GPP TS 36.321 V17.1.0, 3GPP TS 36.322 V17.0.0, 3GPP TS 36.323 V17.1.0, 3GPP TS 36.331 V17.1.0, 3GPP TS 37.324 V17.0.0, 3GPP TS 37.340 V17.1.0, 3GPP TS 38.201 V17.0.0, 3GPP TS 38.202 V17.2.0, 3GPP TS 38.211 V17.2.0, 3GPP TS 38.212 V17.2.0, 3GPP TS 38.213 V17.2.0, 3GPP TS 38.214 V17.2.0, 3GPP TS 38.215 V17.1.0, 3GPP TS 38.300 V17.1.0, 3GPP TS 38.321 V17.1.0, 3GPP TS 38.322 V17.1.0, 3GPP TS 38.323 V17.1.0, 3GPP TS 38.331 V17.1.0, RP-213554, R1-2204881, and R1-2205554 are disclosed as related art.

### SUMMARY

According to an aspect of the embodiments, there is provided a base station including: a control unit that determines to cause a state of a cell to transition to a second state in which transmission of a downlink signal in the cell is restricted; and a transmitting unit that transmits, to a terminal, a first signal that includes first information that indicates that the cell is to transition to the second state, wherein a period of the second state is equal to or greater than a multiple of a cycle of a discontinuous reception (DRX) state of the terminal.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of a wireless communication system according to a first embodiment;

FIG. 2 is an example of a functional block configuration diagram of a base station in the wireless communication system of the first embodiment;

FIG. 3 is an example of a functional block configuration diagram of a terminal in the wireless communication system of the first embodiment;

FIG. 4 is a diagram illustrating an example of a sequence in a wireless system of the first embodiment;

FIG. 5 is a diagram illustrating an example of an operation flow of the base station according to the first embodiment;

FIG. 6 is a diagram illustrating an example of an operation flow of the terminal according to the first embodiment;

FIG. 7 is a diagram illustrating an example when the method of process 1 is reflected in the specifications (TS38.213) in the first embodiment;

FIGS. 8A and 8B are diagrams illustrating an example of information instructing granularity in a second embodiment;

FIGS. 9A to 9D are diagrams illustrating an example of a configuration of a medium access control control element (MAC CE) including information regarding a second state in the second embodiment;

FIG. 10 is a diagram illustrating an example of an operation flow of a terminal according to a third embodiment;

FIGS. 11A and 11B are diagrams illustrating an example when the method of the third embodiment is reflected in the specifications (TS38.321);

FIG. 12 is a diagram illustrating an example when the method of the third embodiment is reflected in the specifications (TS38.331);

FIG. 13 is an example of a hardware configuration diagram of the base station in the wireless communication system; and

FIG. 14 is an example of a hardware configuration diagram of the terminal in the wireless communication system.

### DESCRIPTION OF EMBODIMENTS

There is room for several technological improvements in the conventional technology of the related art. For example, even if a reference signal is measured in a terminal connected to a cell, there is no signal from a base station forming the cell when the cell is in a cell sleep state, and thus, for example, a radio link failure or a beam failure may be detected. For example, the terminal may erroneously detect the radio link failure or the beam failure even though there is no radio link failure or beam failure.

In addition, for example, when a reference signal is measured in a terminal connected to a cell in the power saving transmission state, the transmission power for the reference signal from the base station forming the cell is lowered, and thus, for example, the radio link failure or the beam failure may be detected. For example, the terminal may erroneously detect the radio link failure or the beam failure even though there is no radio link failure or beam failure.

Therefore, in order to lessen erroneous detection and the like in a terminal connected to a cell in the cell sleep state or the power saving transmission state, control relating to measurement in the terminal according to the state of the cell is desired, but a specific implementation method is not studied in the actual situation.

The disclosed technique has been made in view of the above, and an object thereof is to provide a terminal, a base station, and a wireless communication system that enable control relating to measurement in a terminal according to a state of a cell connected with the terminal.

Hereinafter, the present embodiments will be described in detail with reference to the drawings. Problems and embodiments in the present description are merely examples and do not limit the scope of rights of the present application. For example, as long as the described expressions are technically equivalent even if they are different, such different expressions do not limit the scope of rights, and the techniques of the present application can be applied. Then, each of the embodiments can be appropriately combined within a range without causing contradiction between the processing contents.

In addition, it is also permissible if, as the used terms and the described technical contents in the present description, terms and technical contents described in specifications and contributions as standards relating to communication, such as the 3GPP, are appropriately used. Such specifications are described in 3GPP TS 36.133 V17.6.0 to 3GPP TS 38.331 V17.1.0, for example.

Hereinafter, embodiments of a base station, a terminal, and a wireless communication system disclosed in the present application will be described in detail with reference to the drawings. Note that the following embodiments do not limit the disclosed technique.

### First Embodiment

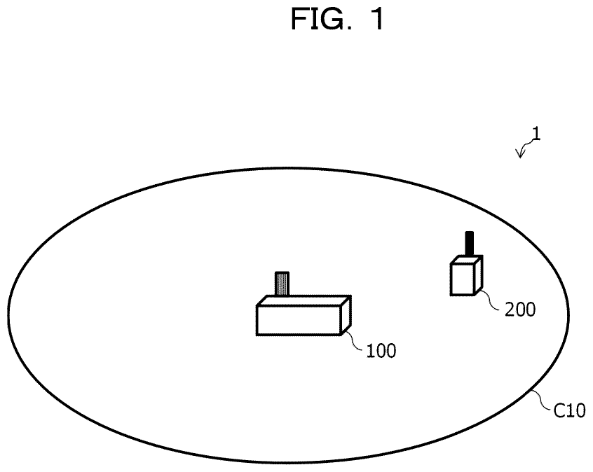

FIG. 1 illustrates a wireless communication system 1 according to a first embodiment. The wireless communication system 1 includes a base station 100 and a terminal 200. Note that the base station 100 forms a cell C10. The terminal 200 resides in the cell C10.

Note that the base station 100 may be, for example, a macro wireless base station, a small wireless base station such as a pico wireless base station (including a micro wireless base station, a femto wireless base station, and the like), or a wireless base station of other different scales and may be rephrased and referred to as a wireless communication device, a communication device, a transmitting device, or the like. In addition, the terminal 200 may be, for example, a mobile phone, a smartphone, a personal digital assistant (PDA), a personal computer, various devices of a vehicle or the like having a wireless communication function, or a wireless terminal in equipment (such as a sensor device) or the like, and may also be rephrased as a wireless communication device, a communication device, a receiving device, a mobile station, or the like.

The base station 100 is connected to a network via wired connection with a network device (a host device or another base station) (not illustrated). Note that the base station 100 may be connected to the network device not by wire but wirelessly.

The base station 100 may be set up as separate devices by separating the wireless communication function with the terminal 200 and the digital signal processing and control functions. In this case, the device having the wireless communication function can be called a remote radio head (RRH), and the device having the digital signal processing and control functions can be called a base band unit (BBU). In addition, the RRH may be installed to project from the BBU, and an optical fiber or the like may be adopted for wired connection between the RRH and BBU. Alternatively, connection may be wirelessly achieved. Furthermore, the base station 100 may be separately configured by two types of communication devices, for example, a central unit (CU) and a distributed unit (DU). The DU includes at least a radio frequency (RF) radio circuit, but besides this, may be provided also with a function of a radio physical layer (or layer 1) and even with a function of a medium access control (MAC) layer, as well as a function of a radio link control (RLC) layer. In addition, the base station 100 may have a configuration including a radio unit (RU) connected to the DU.

Meanwhile, the terminal 200 communicates with the base station 100 by wireless communication.

Note that, when a radio resource control (RRC) connection is not established with the terminal 200, the base station 100 performs a process for establishing the RRC connection.

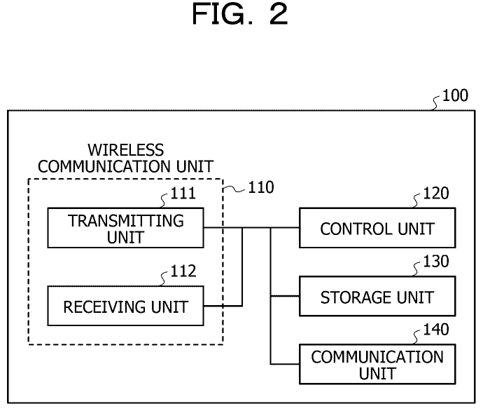

Next, the base station 100 will be described. FIG. 2 illustrates an example of a functional block configuration of the base station 100. The base station 100 includes a wireless communication unit 110, a control unit 120, a storage unit 130, and a communication unit 140.

The wireless communication unit 110 is constituted by a transmitting unit 111 and a receiving unit 112 and performs wireless communication with the terminal 200. Note that the transmitting unit 111 may be constituted by one or a plurality of transmission units. For example, the transmitting unit 111 transmits, to the terminal 200, downlink signals such as a signal for a random access procedure, a signal in a radio resource control (RRC) layer, a downlink data signal, a downlink control signal, and a downlink reference signal.

In addition, the receiving unit 112 can receive, for example, uplink signals transmitted from the terminal 200, such as a signal for the random access procedure, a signal in the RRC layer, an uplink data signal, an uplink control signal, and an uplink reference signal.

The control unit 120 controls the base station 100. For example, the control unit 120 can control establishment of the RRC connection with the terminal 200, state control of the cell C10, signal processing for a signal received by the receiving unit 112, creation of a transport block (TB), mapping of the transport block to a wireless resource, and the like.

The storage unit 130 is capable of storing downlink data signals, for example.

The communication unit 140 is connected to a network device (such as a host device or another base station) by wire or wirelessly to perform communication. The data signals directed to the terminal 200 that have been received by the communication unit 140 can be stored in the storage unit 130.

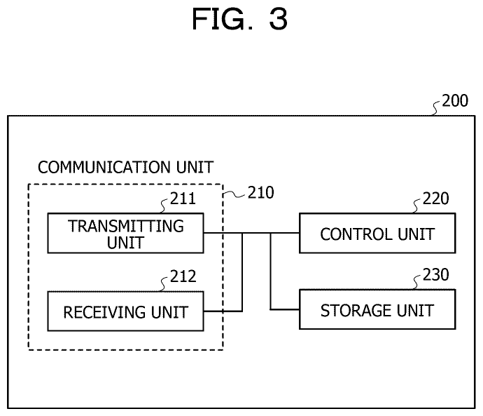

Next, the terminal 200 will be described. FIG. 3 is an example of a functional block configuration diagram of the terminal 200 in the wireless communication system of the first embodiment. As illustrated in FIG. 3, the terminal 200 includes a communication unit 210, a control unit 220, and a storage unit 230. Each of those components is coupled in such a manner that signals and data can be input and output unidirectionally or bidirectionally. Note that the communication unit 210 can be described separately as a transmitting unit 211 and a receiving unit 212.

The transmitting unit 211 transmits data signals and control signals via an antenna by wireless communication. Note that the antenna may be common for transmission and reception. Note that the transmitting unit 211 may be constituted by one or a plurality of transmission units. The transmitting unit 211 transmits, for example, uplink signals such as a signal for the random access procedure, a signal in the RRC layer, an uplink data signal, an uplink control signal, and an uplink reference signal.

The receiving unit 212 receives, for example, downlink signals transmitted from the base station 100, such as a signal for the random access procedure, a downlink data signal, and a downlink control signal. In addition, the signals to be received may include, for example, a reference signal to be used for channel estimation and demodulation.

The control unit 220 controls the terminal 200. For example, the control unit 220 can control establishment of the RRC connection with the base station 100, control relating to radio measurement, signal processing for a signal received by the receiving unit 212, creation of a transport block (TB), mapping of the transport block to a wireless resource, and the like.

The storage unit 230 is capable of storing uplink data signals, for example. In addition, the storage unit 230 is capable of storing configuration information (or setting information) regarding wireless communication transmitted from the base station 100.

Next, a control method relating to measurement in the terminal 200 according to the state of the cell C10 formed by the base station 100 will be described.

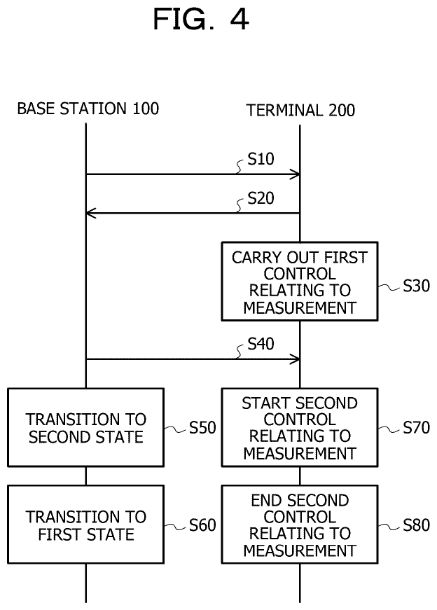

FIG. 4 is a diagram illustrating an example of a sequence in a wireless system 1. Note that a control method relating to measurement in the terminal 200 according to the state of the cell C10 formed by the base station 100 will be described with reference to FIG. 4.

The transmitting unit 111 of the base station 100 transmits a first signal including configuration information regarding measurement to the terminal 200 (step S10). Note that the first signal is, for example, an RRC layer signal. Note that the signal in the RRC layer is, for example, an RRC Reconfiguration message, an RRC Resume message, or an RRC Setup message. Note that the configuration information includes, for example, at least one of information regarding measurement of a reference signal, information regarding beam failure detection (BFD), information regarding radio link monitoring (RLM), information regarding measurement report (MR), and information regarding a synchronization signal block (SSB) based measurement timing configuration window (SMTC).

When the receiving unit 212 receives the first signal including the configuration information regarding the measurement, the control unit 220 of the terminal 200 makes settings relating to the measurement, according to the configuration information regarding the measurement.

When the settings relating to the measurement is completed, the transmitting unit 211 of the terminal 200 transmits a second signal indicating that the settings relating to the measurement have been completed, to the base station 100 (step S20). Note that the second signal is, for example, an RRC layer signal. Note that the signal in the RRC layer is, for example, an RRC Reconfiguration Complete message, an RRC Resume Complete message, or an RRC Setup Complete message.

The control unit 220 of the terminal 200 carries out first control relating to the measurement (step S30). Note that the terminal 200 is connected to the cell C10 of the base station 100. Note that the first control relating to the measurement is according to, for example, the configuration information included in the signal received in step S10. Note that details of the first control relating to the measurement will be described later.

The transmitting unit 111 of the base station 100 transmits a third signal including information regarding a second state to the terminal 200 (step S40). Note that a first state is, for example, a state in which a downlink reference signal is periodically or aperiodically transmitted to the terminal 200. Therefore, in a case where the cell C10 is in the first state, the terminal 200 is allowed to measure the downlink reference signal from the base station 100. In addition, the second state is, for example, a state in which the base station 100 restricts the transmission of the downlink reference signal to the terminal 200 and is, for example, a state in which the downlink reference signal is not transmitted. Note that a state in which the downlink reference signal is not transmitted may be referred to as a cell sleep state. In a case where the cell C10 is in the cell sleep state, the cell C10 does not transmit a downlink signal and therefore, is in a state in which a downlink reference signal is not transmitted. For example, the cell sleep state is an example of the second state. The information regarding the second state is an example of first information. In addition, the second state is, for example, a state in which the base station 100 reduces the transmission units and/or the transmission power with which the downlink reference signal is transmitted to the terminal 200. Note that a state in which the transmission units and/or transmission power with which the downlink reference signal is transmitted are reduced may be referred to as a power saving transmission state. In a case where the cell C10 is in the power saving transmission state, the cell C10 reduces the transmission units and/or the transmission power with which the downlink signal is transmitted and therefore, is in a state in which the transmission units and/or the transmission power with which the downlink reference signal is transmitted are reduced. For example, the power saving transmission state is an example of the second state. The information regarding the second state is an example of the first information.

Note that the third signal including the information regarding the second state is, for example, a signal in the RRC layer, a signal in a medium access control (MAC) layer, or a signal in a physical layer (for example, physical downlink control channel (PDCCH)).

Next, the control unit 120 of the base station 100 causes the cell C10 to transition to the second state from the first state (step S50). Note that steps S40 and S50 may be executed at the same timing.

Next, when an end condition for the second state is satisfied, the control unit 120 of the base station 100 causes the cell C10 to transition to the first state from the second state (step S60). Note that the end condition is, for example, that timer information for the second state has expired. Note that the timer information is included in, for example, the information regarding the second state or information included in the first signal. Alternatively, for example, a predefined value may be used as the timer information.

When the receiving unit 212 of the terminal 200 receives a signal including the information regarding the second state from the base station 100 (step S40), the control unit 220 of the terminal 200 starts second control relating to the measurement on the cell C10 (step S70). For example, control relating to the measurement is switched to the second control from the first control. Note that the start timing of the second control is according to, for example, at least one of the timing of receiving the third signal including the information regarding the second state, the information regarding the second state, preset information, or information set in a signal in the RRC layer. Note that details of the second control relating to the measurement will be described later.

Next, the control unit 220 of the terminal 200 ends the second control relating to the measurement (step S80). Note that the first control may be started in response to the end of the second control. For example, control relating to the measurement may be switched to the first control from the second control.

By executing the first control, the control unit 220 of the terminal 200 is allowed to conduct appropriate measurement on the cell C10 after the base station 100 has released the second state.

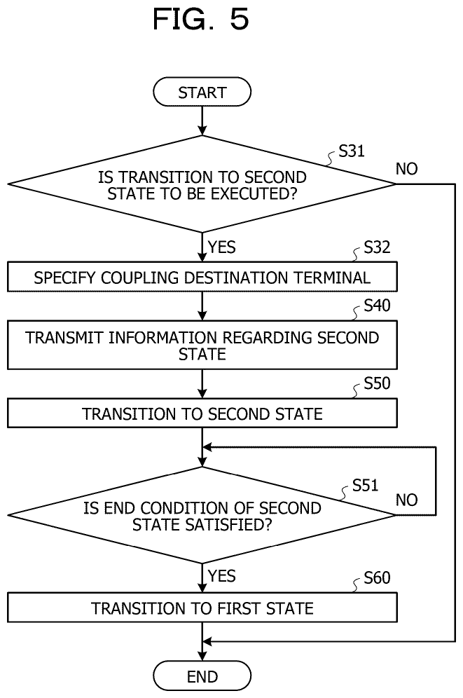

Next, an example of an operation flow of the base station 100 will be described. FIG. 5 is a diagram illustrating an example of an operation flow of the base station 100. Note that, in FIG. 5, parts similar to those in FIG. 4 have the same step numbers.

The control unit 120 of the base station 100 determines whether or not to cause the cell C10 to transition to the second state (step S31). Note that, when determining not to transition to the second state (No in step S31), the control unit 120 of the base station 100 maintains the state of the cell C10 in the first state and ends the process.

When determining to cause the state of the cell C10 to transition to the second state (Yes in step S31), the control unit 120 of the base station 100 specifies the terminal 200 connected to the cell C10 (step S32). Thereafter, the transmitting unit 111 of the base station 100 transmits the third signal including the information regarding the second state to the specified terminal 200 (step S40).

Next, the control unit 120 of the base station 100 causes the cell C10 to transition to the second state from the first state (step S50). Note that steps S40 and S50 may be executed at the same timing.

Next, the control unit 120 of the base station 100 verifies whether an end condition of the second state is satisfied (step S51). In a case where the end condition of the second state is not satisfied (step S51: No), the control unit 120 of the base station 100 maintains the state of the cell C10 in the second state until the end condition of the second state is satisfied.

In a case where the end condition of the second state is satisfied (step S51: Yes), the control unit 120 of the base station 100 causes the state of the cell C10 to transition to the first state (step S60) and ends the process. For example, the control unit 120 of the base station 100 causes the state of the cell C10 to transition to the first state from the second state.

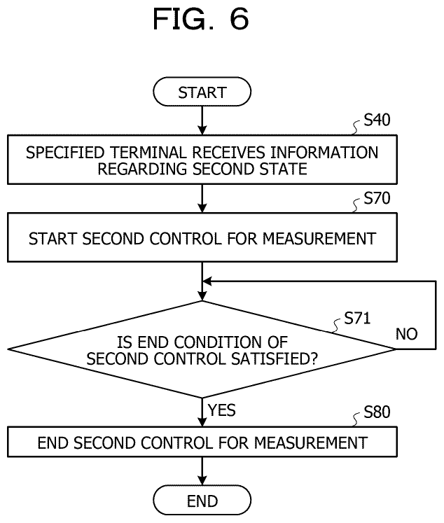

Next, an example of an operation flow of the terminal 200 will be described. FIG. 6 is a diagram illustrating an example of an operation flow of the terminal 200. Note that, in FIG. 6, parts similar to those in FIG. 4 have the same step numbers.

When the receiving unit 212 of the terminal 200 receives the third signal including the information regarding the second state from the base station 100 (step S40), the control unit 220 of the terminal 200 starts the second control relating to the measurement on the cell C10 (step S70).

The control unit 220 of the terminal 200 verifies whether or not an end condition for ending the second control relating to the measurement is satisfied (step S71). In a case where the end condition of the second control relating to the measurement is not satisfied (step S71: No), the control unit 220 of the terminal 200 maintains the second control relating to the measurement.

In a case where the end condition of the second control relating to the measurement is satisfied (step S71: Yes), the control unit 220 of the terminal 200 ends the second control relating to the measurement (step S80) and ends the process according to the second state of the cell C10.

Note that the end condition of the second control relating to the measurement is, for example, that a timer for the second state has expired. Note that the timer is according to, for example, information included in at least one of the information regarding the second state transmitted in step S40 and the first signal transmitted in step S10. In addition, for the end condition of the second control relating to the measurement, for example, the time when uplink data is produced may be treated as the end condition. In this case, the terminal 200 may operate to connect to a cell (another cell) different from the cell C10. For example, the connection is changed to a cell that is not in the second state (for example, the cell sleep state) in order to transmit the uplink data. Note that, for connection change, the connection is changed, for example, by setting RRC between another cell and the terminal 200. Note that, when uplink data is produced in the terminal 200, the cell connection may not be changed in a case where a predetermined condition is satisfied. This ensures that, in a case where the data transmission does not have to be performed before the period of the cell sleep expires, the uplink data is transmitted after the timer for the second state has expired, for example, after the cell C10 has transitioned to the first state.

In addition, the control unit 220 of the terminal 200 can measure the downlink reference signal after the cell C10 has transitioned to the first state from the second state, by carrying out the first control relating to the measurement after the second control relating to the measurement has ended.

### First Control Relating to Measurement

The first control relating to the measurement performed by the control unit 220 of the terminal 200 will be described.

The first control relating to the measurement executes control of the measurement according to the configuration information included in a signal received from the base station 100. For example, the downlink reference signal transmitted from the base station 100 is measured, and execution of beam failure detection (BFD), radio link monitoring (RLM), and/or measurement report (MR) according to the measurement result is controlled. In addition, for the measurement, an SSB based measurement timing configuration window (SMTC window) may be sometimes used. Note that the SMTC window is a technique for decreasing power consumption of the terminal 200 by defining a measurement timing, a measurement cycle, and measurement time of a synchronization signal block (SSB) or a channel state information-reference signal (CSI-RS) used for the measurement. For example, the configuration information includes at least one of information regarding the measurement of the downlink reference signal, information regarding the BFD, information regarding the MR, or information regarding the SMTC.

The BFD will be described. The BFD is an example of a process of detecting a beam failure in a cell by the terminal 200 performing the following process.

The physical layer of the terminal 200 measures a reference signal in the cell. Then, when the received power (reference signal received power (RSRP)) of the reference signal falls below a threshold value, the physical layer of the terminal 200 generates a beam failure instance (BFI) and transmits the generated BFI to the MAC layer of the terminal 200. Note that examples of the cell type include a primary cell (P cell), a primary secondary cell (PS cell), and a secondary cell (S cell). Note that the PS cell may be sometimes in a deactivated state. In addition, examples of the type of the reference signal include periodic CSI-RS and SSB.

When receiving the BFI, the MAC layer of the terminal 200 increases a BFI counter by one, activates or restarts a timer (beam failure detection timer), and detects a beam failure when the BFI becomes greater than a predetermined threshold value (beam failure instance max count) before the timer expires.

Next, the RLM will be described. The RLM is an example of a process of detecting a failure of a radio link by the terminal 200 performing the following process.

The physical layer of the terminal 200 measures the radio link quality of the set reference signal and sends information according to the measurement result to the RRC layer of the terminal 200. Note that examples of the cell type include the P cell, and the PS cell in a deactivated state. In addition, examples of the type of the reference signal include periodic CSI-RS and SSB. Furthermore, the information according to the measurement result is, for example, the first information (out-of-sync) in a case where a block error rate (BLER) is equal to or greater than a predetermined threshold value in measurement evaluation time and is second information (in-sync) in a case where the BLER is less than the predetermined threshold value in the measurement evaluation time.

When consecutively receiving the first information (out-of-sync) from the physical layer a predetermined number of times (N310), the RRC layer of the terminal 200 starts a timer (T310). Then, when the timer (T310) has expired, the RRC layer of the terminal 200 detects a radio link failure. Note that, when consecutively receiving the second information (in-sync) a predetermined number of times (N311) from the physical layer while the timer (T310) is in a running state, the RRC layer of the terminal 200 stops the timer (T310).

Note that the timer (T310), the predetermined number of times (N310), and the predetermined number of times (N311) are set by, for example, information included in the signal in the RRC layer transmitted in step S10 described in FIG. 4.

Next, the MR will be described. The MR is an example of a process of reporting the radio link measurement result to the base station by the terminal 200 performing the following process.

The terminal 200 measures reference signals of neighboring cells. Note that the type of the reference signal is, for example, the CSI-RS or SSB.

The terminal 200 reports, as a measurement result for a neighboring cell, at least one of, for example, a measurement result for each SSB (RSRP, reference signal received quality (RSRQ), or signal-to-interference-plus-noise ratio (SINR)), a measurement result for each cell based on the SSB (RSRP, RSRQ, or SINR), an SSB index, a measurement result for each CSI-RS (RSRP, RSRQ, or SINR), a measurement result for each cell based on the CSI-RS (RSRP, RSRQ, or SINR), and a CSI-RS resource measurement identifier, to the base station 100.

Note that the reporting timing includes a periodic timing and a timing at which an event occurs.

### Second Control Relating to Measurement

The second control relating to the measurement performed by the control unit 220 of the terminal 200 will be described.

The second control relating to the measurement is control for performing at least one of following processes 1 to 4. Note that process 2 is a process related to the BFD, process 3 is a process related to the RLM, and process 4 is a process related to the MR.

Process 1 is a process in which the control unit 220 of the terminal 200 takes control to skip a part or the whole of the measurement of the reference signal (SSB and/or CSI-RS) set to be measured by the signal in the RRC layer. For example, the process is a process in which the terminal 200 does not perform a part or the whole of the measurement of the reference signal set to be measured.

Process 2 is a process in which the control unit 220 of the terminal 200 takes control to perform at least any one of the followings.
The physical layer of the terminal 200 does not report the BFI to the MAC layer of the terminal 200 even when detected.
The RRC layer of the terminal 200 does not raise the counter even when

receiving the BFI, or increases the counter only under a particular condition (for example, the cell is not in the cell sleep state, or the cell sleep period of the cell is shorter than a multiple of a discontinuous reception (DRX) cycle).
The counter is set to zero.

Process 3 is a process in which the control unit 220 of the terminal 200 takes control to perform at least any one of the followings.
The physical layer of the terminal 200 does not transmit the first information (out-of-sync) to the RRC layer of the terminal 200 even when detected.
The RRC layer of the terminal 200 resets N310 even when receiving the first information (out-of-sync).
The RRC layer of the terminal 200 sets the timer (T310) to zero.
The RRC layer of the terminal 200 stops the timer (T310).
The RRC layer of the terminal 200 does not start the timer (T310).

Process 4 is a process in which the control unit 220 of the terminal 200 takes control to perform at least any one of the followings.
The measurement result is not transmitted even when the periodic measurement result reporting timing has come.
The measurement result is not transmitted even when an event that involves reporting a measurement result is detected.

Note that processes 1 to 4 are, for example, processes relating to measurement by the control unit 220 of the terminal 200 using a second threshold value according to the second state. Note that the second threshold value includes, for example, at least one of an RSRP threshold value related to generation of the BFI, a threshold value related to the BFI counter, a BLER threshold value related to out-of-sync or in-sync, a threshold value related to the predetermined number of times of out-of-sync or in-sync (N310 or N311), and a threshold value related to an event that involves reporting a measurement result (RSRP, RSRQ, or SINR) of the SSB or CSI-RS to the base station. Note that the process relating to the measurement is a process for controlling execution of at least any one of the BFD, RLM, and MR.

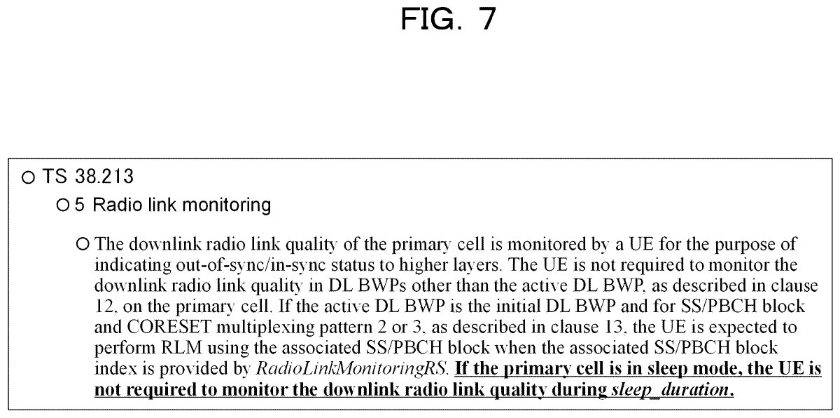

Note that, as an example, FIG. 7 illustrates an example when the contents of process 1 are reflected in the specifications (TS38.213). As described in FIG. 7, by including the method of process 1 in the description of 5 Radio link monitoring, process 1 can be defined in the specifications.

As described above, by executing the second control relating to the measurement, the radio measurement in the terminal 200 can be restricted in a case where the cell C10 enters the second state and the reference signal transmitted from the base station 100 is restricted. Accordingly, the terminal 200 is allowed to control the measurement according to the state of the connected cell.

For example, when the cell C10 is in the cell sleep state or the power saving transmission state, since the terminal 200 is controlled so as not to measure the reference signal, erroneous detection of the beam failure or the radio link failure may be suppressed.

In addition, for example, when the cell C10 is in the cell sleep state or the power saving transmission state, the physical layer of the terminal 200 does not report the BFI to the MAC layer of the terminal 200 even when detected, and thus, the beam failure is not detected in the MAC layer of the terminal 200. Accordingly, erroneous detection of the beam failure may be suppressed.

Furthermore, for example, by performing control so as not to report the first information (out-of-sync) in the physical layer of the terminal 200 when the cell C10 is in the cell sleep state or the power saving transmission state, the radio link failure is not detected in the RRC layer of the terminal 200. Accordingly, erroneous detection of the radio link failure may be suppressed.

In addition, for example, by controlling the terminal 200 so as not to report the measurement result when the cell C10 is in the cell sleep state or the power saving transmission state, transmission of an erroneous measurement result to the base station 100 may be suppressed.

Furthermore, for example, when the cell C10 is in the cell sleep state or the

power saving transmission state, the terminal 200 controls the measurement execution using the second threshold value. Accordingly, erroneous detection of the beam failure or the radio link failure or transmission of an erroneous measurement result to the base station 100 may be suppressed.

As described above, in the first embodiment, the terminal 200 receives a signal indicating that the state of the cell C10 is to transition and executes measurement control according to the state of the cell C10 after the transition. With this control, the terminal 200 may be allowed to control measurement according to the state of the cell C10 and may suppress erroneous detection of the beam failure, erroneous detection of the radio link failure, and the like, for example.

In addition, in a case where the second state is the cell sleep state, since it is known that the cell C10 is in the cell sleep state, the terminal 200 may be allowed to take control so as not to release the connection with the cell C10. This ensures that, when the cell C10 enters the first state, connection to the cell C10 can be achieved using the configuration information before the cell sleep, and thus, a signal for connecting to the cell C10 again may not have to be exchanged.

### Second Embodiment

In the first embodiment, an example has been described in which the base station 100 transmits the third signal including the information regarding the second state to the terminal 200 such that the terminal 200 performs control according to the state of the cell C10. In a second embodiment, specific examples of the third signal including the information regarding the second state will be described. Note that, in the second embodiment, a wireless communication system, a base station, and a terminal are similar to those in the first embodiment, and thus, descriptions thereof will be omitted.

Note that the third signal including the information regarding the second state includes a signal in the physical layer and a signal in the MAC layer. Therefore, each example will be described.

A case where the third signal including the information regarding the second state is a signal in the physical layer will be described. In a case where the third signal including the information regarding the second state is a signal in the physical layer, a terminal 200 is notified of the information regarding the second state by a base station 100, using, for example, a PDCCH that is a channel for a downlink control signal.

Note that the PDCCH includes downlink control information (DCI). For example, the information regarding the second state is transmitted as a part of the information included in the DCI.

In a case where a cell C10 transitions to the second state, the base station 100 includes, as the information regarding the second state, at least one of information on the timing at which the cell C10 enters the second state, instruction information to cause the cell C10 to enter the second state, information on a period in which the cell C10 is in the second state, instruction information not to execute a process relating to the measurement of the reference signal, or instruction information to use a second threshold value.

For example, in a case where the information regarding the second state includes the information on the timing at which the cell C10 enters the second state, a control unit 220 of the terminal 200 takes control to perform the second control relating to the measurement during a period in which the cell C10 is in the second state from a timing at which the cell C10 enters the second state.

In addition, for example, in a case where the information regarding the second state includes the instruction information to cause the cell C10 to enter the second state, the control unit 220 of the terminal 200 takes control to perform the second control relating to the measurement during a period in which the cell C10 is in the second state from a timing at which the instruction information to cause the cell C10 to enter the second state is received.

Furthermore, for example, in a case where the information regarding the second state includes the instruction information not to execute a process relating to the measurement of the reference signal, control is taken such that control relating to the measurement is not performed during a period in which the cell C10 is in the second state from a timing at which the instruction information not to execute a process relating to the measurement of the reference signal is received.

In addition, for example, in a case where the information regarding the second state includes the instruction information to use the second threshold value, control is taken such that control relating to the measurement using the second threshold value is performed during a period in which the cell C10 is in the second state from a timing at which the instruction information to use the second threshold value is received.

Note that, in a case where the information regarding the second state does not include information on the period in which the second state is kept, for example, the information on the period in which the second state is kept is transmitted by the first signal transmitted in step S10 in FIG. 4.

By transmitting the information on the period in which the second state is kept by the first signal, the overhead of the signal may be reduced.

Next, an example in which the information on the period in which the second state is kept is transmitted by the DCI will be described.

The information on the period in which the second state is kept includes information instructing granularity and information indicating the duration of the second state. For example, the period in which the second state is kept can be represented by the granularity and the information indicating the duration of the second state.

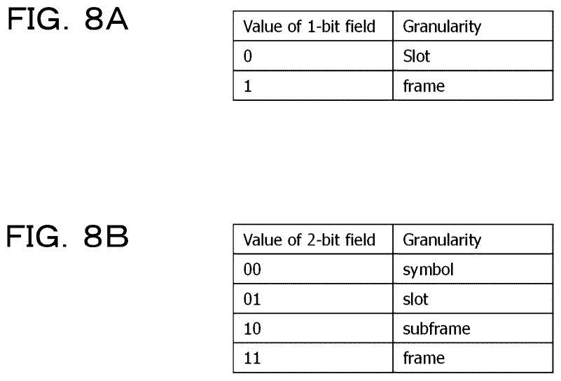

FIGS. 8A and 8B illustrate an example of the information instructing the granularity. FIG. 8A represents an example in which the information instructing the granularity has one bit, which is an example in which a slot is indicated when the information instructing the granularity has “0” and a frame is indicated when the information instructing the granularity has “1”.

In addition, FIG. 8B represents an example in which the information instructing the granularity has two bits, which is an example in which a symbol is indicated when the information instructing the granularity has “00”, a slot is indicated when the information instructing the granularity has “01”, a subframe is indicated when the information instructing the granularity has “10”, and a frame is indicated when the information instructing the granularity has “11”.

For example, in a case where the information instructing the granularity indicates the slot and the information indicating the duration of the second state indicates 10, it indicates that the cell C10 is in the second state for a period of 10 slots.

In addition, for example, in a case where the information instructing the granularity indicates the frame and the information indicating the duration of the second state indicates 10, it indicates that the cell C10 is in the second state for a period of 10 frames.

In this manner, the period in which the cell C10 is in the second state can be dynamically changed.

In addition, a plurality of periods in which the second state is kept is set by the signal in the RRC layer transmitted in step S10 in FIG. 4, and indices or identifiers are given to each of the plurality of periods in which the second state is kept. Then, the information on the period in which the second state is kept included in the DCI may be treated as an index or an identifier.

In addition, a first threshold value and the second threshold value are set by the signal in the RRC layer transmitted in step S10 of FIG. 4, and indices or identifiers are given to each of the first threshold value and the second threshold value. Then, the information on the second threshold value included in the DCI may be treated as an index or an identifier. Note that, as the index or the identifier, for example, an index or an identifier instructing a transmission configuration indicator (TCI) state may be used.

Next, a case where the third signal including the information regarding the second state is a signal in the MAC layer will be described. In a case where the third signal including the information regarding the second state is a signal in the MAC layer, the information regarding the second state is included in, for example, a medium access control control element (MAC CE), and the terminal 200 is notified of the information regarding the second state by the base station 100.

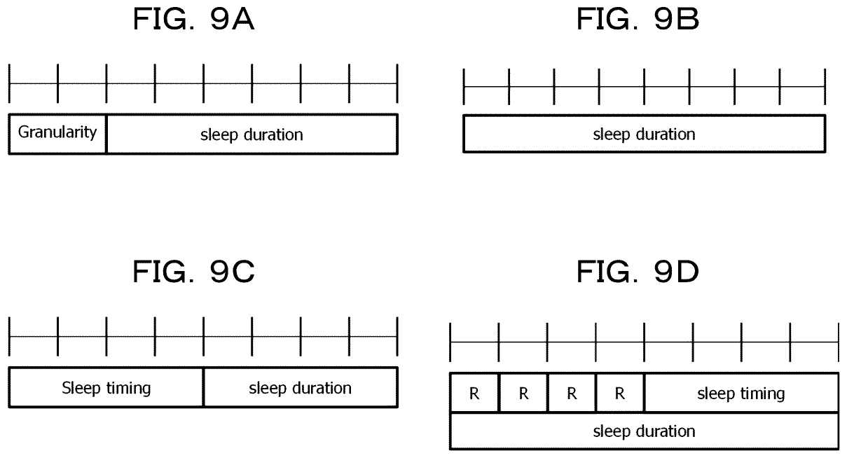

FIGS. 9A to 9D are diagrams illustrating an example of a configuration of the MAC CE including the information regarding the second state. Note that FIGS. 9A to 9D are depicted as an example in which the second state is the cell sleep state.

FIG. 9A represents an example in which the MAC CE includes granularity information (granularity) and information indicating a period of the cell sleep (sleep duration) as the information regarding the second state. In addition, FIG. 9B represents an example in which the MAC CE includes information indicating a period of the cell sleep (sleep duration).

FIG. 9C represents an example in which the MAC CE includes timing information (sleep timing) on transitioning to the cell sleep and information indicating a period of the cell sleep (sleep duration), as the information regarding the second state. In addition, FIG. 9D represents an example in which the first octet of the MAC CE includes timing information on transitioning to the cell sleep (sleep timing) and the second octet includes information indicating a period of the cell sleep (sleep duration), as the information regarding the second state. Note that the first octet in FIG. 9D is treated as 4-bit reserved bits (R). Note that the second octet in FIG. 9D may be constituted by the granularity information (granularity) and the information indicating a period of the cell sleep (sleep duration) as in FIG. 9A.

FIGS. 9A to 9D may be depicted as an example in which the second state is the power saving transmission state. In that case, for example, the information indicating a period of the cell sleep (sleep duration) is replaced with information indicating a period of the power saving transmission state. In addition, for example, the timing information on transitioning to the cell sleep (sleep timing) is replaced with timing information on transitioning to the power saving transmission state.

Note that, in a case where the granularity information is not included in the MAC CE, for example, the granularity may be preset, or the granularity information may be included in a subheader of the MAC CE.

Note that, since the subheader of the MAC CE includes a logical channel identifier (LCID), the LCID can be used to indicate that the cell C10 is to go to the cell sleep, and the MAC CE can indicate details of the cell sleep.

As described above, in the second embodiment, an example in which the information regarding the second state is included in the DCI or the MAC CE and transmitted has been described. The terminal 200 executes measurement control according to the state of the cell C10 after the transition, by receiving a signal in the physical layer or a signal in the MAC layer including the information regarding the second state. With this control, the terminal 200 may be allowed to control measurement according to the state of the cell C10 and may suppress erroneous detection of the beam failure and erroneous detection of the radio link failure, for example.

### Third Embodiment

In the first embodiment, an example has been described in which the base station 100 transmits the third signal including the information regarding the second state to the terminal 200 such that the terminal 200 performs control according to the state of the cell C10. In the second embodiment, specific examples of the third signal including the information regarding the second state have been described. In a third embodiment, an example of specific control relating to the measurement in a terminal 200 will be described. Note that, in the third embodiment, a wireless communication system, a base station, and a terminal are similar to those in the first embodiment, and thus, descriptions thereof will be omitted.

In addition, in the third embodiment, an example of the BFD will be used and described as an example of control relating to the measurement.

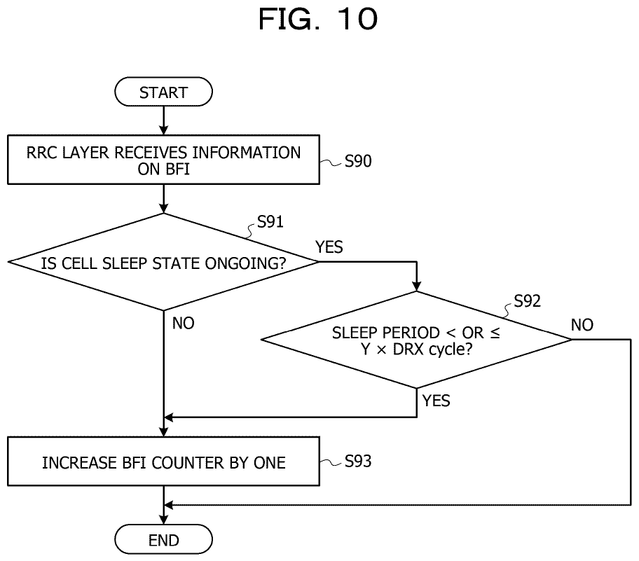

FIG. 10 is a diagram illustrating an example of an operation flow of the terminal 200. Note that FIG. 10 illustrates an example of an operation flow in the BFD. Note that it is supposed in FIG. 10 that the second state of the cell C10 is the cell sleep state. In addition, as the second control relating to the measurement, a description will be given taking, as an example, that the RRC layer of the terminal 200 performs control so as not to raise the counter even when receiving the BFI or to increase the counter only under a particular condition (for example, the cell is not in the cell sleep state, or the cell sleep period of the cell is shorter than a multiple of the DRX cycle).

The RRC layer of the terminal 200 receives the BFI from the physical layer (step S90).

A control unit 220 of the terminal 200 verifies whether or not the cell C10 is in the cell sleep state (step S91).

When verifying that the cell C10 is in the cell sleep state (step S91: Yes), the control unit 220 of the terminal 200 confirms whether the period of the cell sleep is equal to or less than Y times the DRX cycle or whether the period of the cell sleep is less than Y times the DRX cycle (step S92).

In a case where the period of the cell sleep is greater than Y times the DRX cycle or the period of the cell sleep is equal to or greater than Y times the DRX cycle (step S92: No), control to increase the BFI counter (increment of the BFI counter) is not performed. Note that, since the BFI counter is not increased, the timer (beam failure detection timer) is not started either.

When verifying that the cell C10 is not in the cell sleep state (step S91: No), or when confirming that the period of the cell sleep is equal to or less than Y times the DRX cycle or the period of the cell sleep is less than Y times the DRX cycle (step S92: Yes), the control unit 220 of the terminal 200 increases the BFI counter by one (increments the BRI) and starts or restarts the timer (beam failure detection timer).

Note that step S92 may be excluded. In a case where step S92 is excluded, when verifying that the cell C10 is in the cell sleep state (step S91: Yes), the control unit 220 of the terminal 200 takes control so as not to perform control to increase the BFI counter (increment of the BFI counter).

By controlling as described above, the terminal 200 can perform control according to the state of the cell C10. Note that whether or not the cell sleep state is ongoing can be verified by receiving a signal transmitted in step S40 in FIG. 4.

In addition, the DRX cycle corresponds to either the Long DRX cycle or the Short DRX cycle.

Furthermore, the value of Y may be designated by the first signal or a signal in the RRC layer, or may be a value defined in advance. Alternatively, a requirement of a BFI instruction interval (minimum interval) or a threshold value for detecting the beam failure (beam failure instance max count) may be considered to make determination. For example, in a case where the threshold value for detecting the beam failure is three, the value of Y is set such that Y times the DRX cycle is equal to or less than twice the minimum interval indicated by the BFI instruction interval. This is because the cell sleep will be released at least before the third BFI for detecting the beam failure is detected.

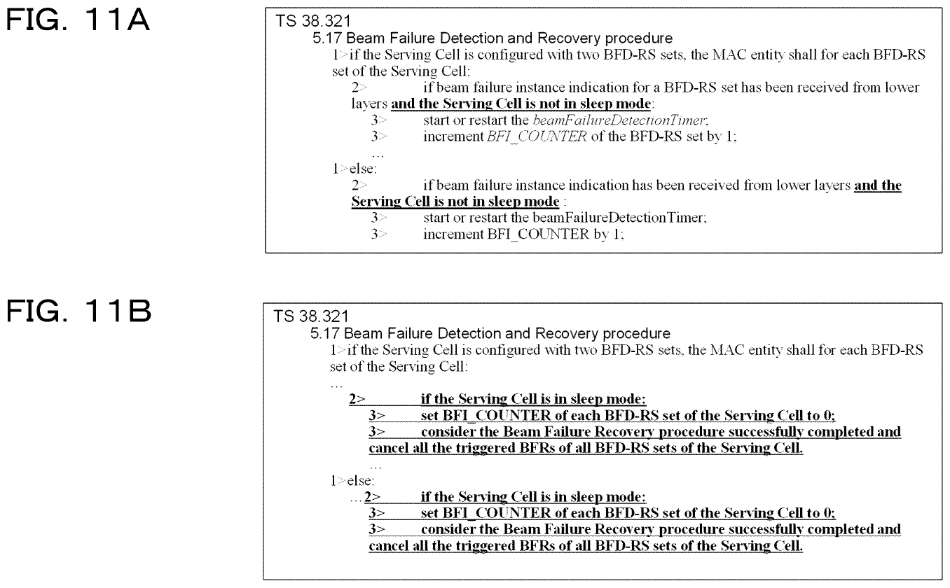

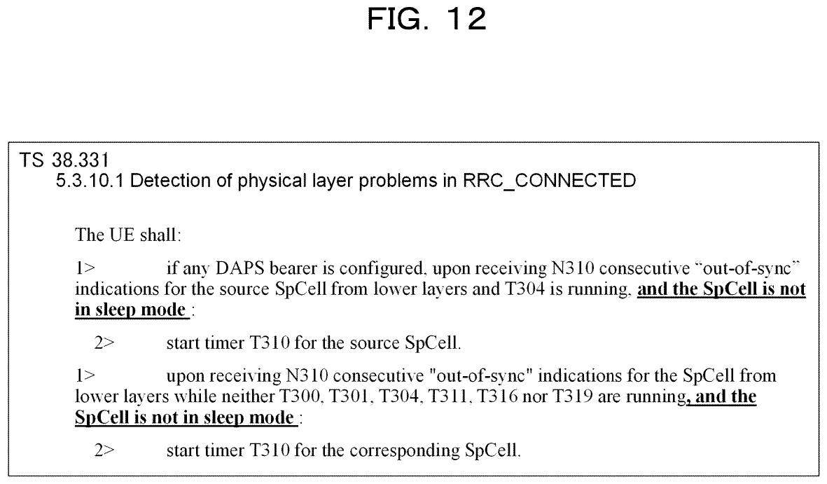

Note that, as an example, FIGS. 11A to 12 illustrate an example when the contents of the third embodiment are reflected in the specifications (TS38.321 and TS38.331). As depicted in FIGS. 11A and 11B, by including the method of the third embodiment in the description of 5.17 Beam Failure Detection and Recovery procedure of TS38.321, the method of the third embodiment can be defined in the specifications. In addition, FIG. 12 depicts an example in which the timer (T310) is set to zero in a case where the cell is in the second state (for example, the cell sleep state or the power saving transmission state).

As depicted in FIG. 12, by including the method of the third embodiment in the description of 5.3.10.1 Detection of physical layer problems in RRC_CONNECTED of TS38.331, the method of the third embodiment can be defined in the specifications.

As described above, in the third embodiment, an example of control relating to the measurement according to the state of the cell C10 in the terminal 200 has been described. By verifying the state of the cell C10, the terminal 200 may be allowed to perform different kinds of control relating to the measurement and may suppress erroneous detection of the beam failure or the radio link failure, for example.

### Hardware Configuration of Each Device in Each Embodiment

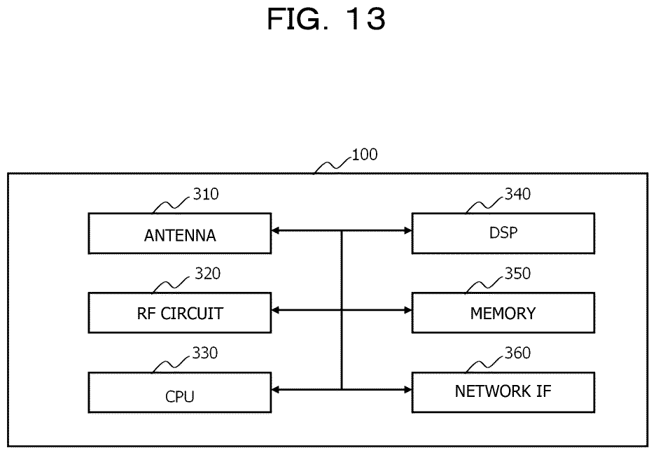

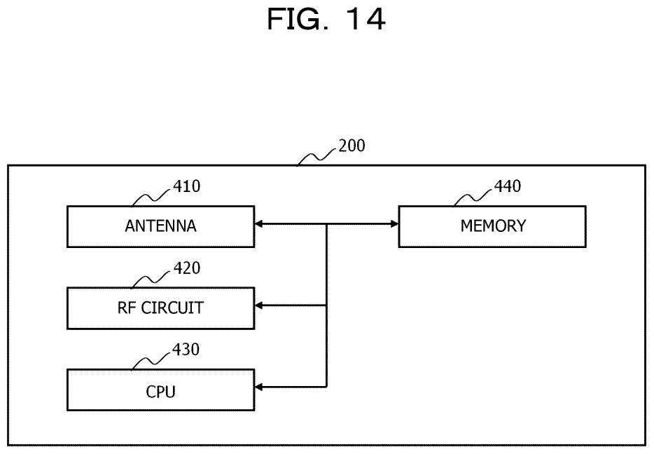

A hardware configuration of each device in the wireless communication system of each embodiment will be described with reference to FIGS. 13 and 14.

FIG. 13 is a diagram illustrating an example of a hardware configuration of the base station 100. As illustrated in FIG. 13, the base station 100 includes, for example, a radio frequency (RF) circuit 320 including an antenna 310, a central processing unit (CPU) 330, a digital signal processor (DSP) 340, a memory 350, and a network interface (IF) 360 as hardware constituent elements. The CPU is coupled such that various kinds of signals and data signals can be input and output via a bus. The memory 350 includes, for example, at least one of a random access memory (RAM) such as a synchronous dynamic random access memory (SDRAM), a read only memory (ROM), or a flash memory and stores programs, control information, and data signals. Note that examples of the programs include a control program that performs various kinds of control.

The correspondence between the functional block configuration of the base station 100 illustrated in FIG. 2 and the hardware configuration of the base station 100 illustrated in FIG. 13 will be described. The transmitting unit 111 and the receiving unit 112 (or the wireless communication unit 110) are implemented by, for example, the RF circuit 320, or the antenna 310 and the RF circuit 320. In addition, the transmitting unit 111 is constituted by, for example, one or a plurality of transmission units and the RF circuit 320, or one or a plurality of antennas 310 and one or a plurality of transmission units, or one or a plurality of transmission units. The transmission unit may be implemented by, for example, the antenna 310, the RF circuit 320, or the antenna 310 and the RF circuit 320. The control unit 120 is implemented by, for example, the CPU 330, the DSP 340, the memory 350, a digital electronic circuit (not illustrated), or the like. As examples of the digital electronic circuit, an application specific integrated circuit (ASIC), a field-programming gate array (FPGA), a large scale integration (LSI), and the like are mentioned. In addition, the communication unit 140 is implemented by, for example, the RF circuit 320, the antenna 310 and the RF circuit 320, or the network interface (IF) 360. For example, the control of the base station 100 of the first to third embodiments is implemented by executing the control program stored in the memory 350.

Note that a plurality of data signals to be transmitted in a plurality of sub-bands can also be generated in the base station 100, where filters for generating these data signals may be configured independently for each sub-band.

FIG. 14 is a diagram illustrating an example of a hardware configuration of the terminal 200. As illustrated in FIG. 14, the terminal 200 includes, for example, an RF circuit 420 including an antenna 410, a CPU 430, and a memory 440 as hardware constituent elements. Moreover, the terminal 200 may include a display device, such as a liquid crystal display (LCD), and a DSP coupled to the CPU 430. The memory 440 includes, for example, at least one of a RAM such as an SDRAM, a ROM, or a flash memory and stores programs, control information, and data signals. Note that examples of the programs include the control program that performs various kinds of control.

The correspondence between the functional block configuration of the terminal 200 illustrated in FIG. 3 and the hardware configuration of the terminal 200 illustrated in FIG. 14 will be described. The transmitting unit 211 and the receiving unit 212 (or the communication unit 210) are implemented by, for example, the RF circuit 420, or the antenna 410 and the RF circuit 420. In addition, the transmitting unit 211 is constituted by, for example, one or a plurality of transmission units and the RF circuit 420, or one or a plurality of antennas 410 and one or a plurality of transmission units, or one or a plurality of transmission units. The transmission unit may be implemented by, for example, the antenna 410, the RF circuit 420, or the antenna 410 and the RF circuit 420. The control unit 220 is implemented by, for example, the CPU 430, the memory 440, a digital electronic circuit (not illustrated), or the like. As examples of the digital electronic circuit, an ASIC, FPGA, LSI, and the like are mentioned. For example, the control of the terminal 200 of the first to third embodiments is implemented by executing the control program stored in the memory 440.

Note that, in each embodiment, examples of the base station and the terminal have been described, but the disclosed technique is not limited thereto and, for example, can be applied to diverse devices such as electronic equipment mounted on automobiles, trains, airplanes, artificial satellites, and the like, electronic equipment carried by drones and the like, robots, audio-visual (AV) equipment, home appliances, office equipment, vending machines, and other home equipment.

In addition, in each embodiment, the 5th generation mobile communication has been mentioned as an example and used for description, but the disclosed technique is not exclusively applied thereto. For example, the disclosed technique may be applied to mobile communication of different generations such as the 6th generation and the 7th generation.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A base station comprising:
a control unit that determines to cause a state of a cell to transition to a second state in which transmission of a downlink signal in the cell is restricted; and
a transmitter that transmits, to a terminal, a first signal that includes first information that indicates that the cell is to transition to the second state, wherein
a period of the second state is equal to or greater than a multiple of a cycle of a discontinuous reception (DRX) state of the terminal.

2. The base station according to claim 1, wherein
the first information includes at least one of information on a timing of transition to the second state and information on a period of the second state.

3. The base station according to claim 1, wherein
the first signal is transmitted by using a physical downlink control channel (PDCCH), and the first information is a part of downlink control information (DCI).

4. The base station according to claim 3, wherein
the information on the period of the second state is expressed by using granularity information.

5. The base station according to claim 2, wherein
the first signal is a signal in a radio resource control (RRC) layer or a signal in a medium access control (MAC) layer.

6. The base station according to claim 2, wherein
the first signal includes a MAC subheader, and the MAC subheader includes the information that indicates that the cell is to transition to the second state.

7. The base station according to claim 1, wherein
the control unit takes control to transition to a first state in which the transmission of the reference signal in the cell is not restricted in a case where a period of the second state has expired.

8. The base station according to claim 1, wherein
the second state is a cell sleep state.

9. The base station according to claim 1, wherein
the second state is a power saving transmission state.

10. A terminal comprising:
a control unit that takes control to carry out first control, as control that relates to measurement; and
a receiver that receives, from a base station, a first signal that includes first information that indicates transition to a second state in which transmission of a downlink signal in a cell is restricted, wherein
the control unit takes control to execute second control different from the first control, according to the first information, in the control that relates to the measurement, and
a period of the second state is equal to or greater than a multiple of a cycle of a discontinuous reception (DRX) state of the terminal.

11. The terminal according to claim 10, wherein
the first control takes control to perform at least any one of beam failure detection, radio link failure detection, or measurement result reporting for the reference signal, and
the second control takes control so as not to execute at least one of processes for the beam failure detection, the radio link failure detection, and the measurement result reporting for the reference signal that are executed in the first control.

12. The terminal according to claim 10, wherein
the first control controls the processes that include: incrementing a counter when a radio resource control (RRC) layer receives count information regarding a beam failure received from a physical layer; and detecting the beam failure when the counter exceeds a predetermined value, and
the second control takes control so as not to increment the counter when the RRC layer receives the count information regarding the beam failure received from the physical layer, or to increment the counter when a predetermined condition is satisfied.

13. A wireless communication system comprising:
a base station that determines to cause a state of a cell to transition to a second state in which transmission of a downlink signal in the cell is restricted, and transmits, to a terminal, a signal that includes first information that indicates that the cell is to transition to the second state; and
the terminal that receives the first signal, and takes control to execute second control as control that relates to measurement, according to the first information, wherein
a period of the second state is equal to or greater than a multiple of a cycle of a DRX state of the terminal.
